(19) United States
(12) Patent Application Publication
(10) Pub. No.: US 2022/0151387 A1
(43) Pub. Date: May 19, 2022

(54) Removably Attachable Mounting Device

(71) Applicant: Diane Ramsey, San Rafael, CA (US)

(72) Inventor: Diane Ramsey, San Rafael, CA (US)

(21) Appl. No.: 17/098,506

(22) Filed: Nov. 16, 2020

(51) Int. Cl. A47B 97/00; G09F 7/18

(52) U.S. Cl. CPC A47B 97/001; G09F 7/18

(57) ABSTRACT

A removably attachable mounting device for removably attaching media to a surface of a wall includes a block, which is resiliently deformable so that the block is repeatedly penetrable by a shaft of a pin. A fastener engaged to a first face of the block can selectively engage a surface so that the block is removably engaged to the surface. An article can be positioned over a second face of the block so that the shaft of the pin can be inserted through the article into the block to mount the article to the surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to mounting device and more particularly pertains to a new mounting device for removably attaching media to a surface of a wall.

### (2) Description of Related Art Including Information Disclosed Under 37 CFR 1.97 and 1.98

The prior art relates to mounting device. Prior art mounting devices may comprise cork boards configured for hanging on or adhesively engaging a wall, bulletin boards comprising a plurality of cork pieces adhesively engaged to a wall, and mounting device comprising releasable adhesives. What is lacking in the prior art is a mounting device comprising a set of cork blocks, wherein each cork block is attachable to a wall via a releasable adhesive positioned on one face thereof.

### BRIEF SUMMARY OF THE INVENTION

An embodiment of the disclosure meets the needs presented above by generally comprising a block, which is resiliently deformable so that the block is repeatedly penetrable by a shaft of a pin. A fastener is engaged to a first face of the block and is configured to selectively engage a surface so that the block is removably engaged to the surface. A second face of the block is configured to have an article positioned thereover. The shaft of the pin can be inserted through the article into the block to mount the article to the surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a removably attachable mounting device according to an embodiment of the disclosure.

FIG. 2 is a back view of an embodiment of the disclosure.

FIG. 3 is a side view of an embodiment of the disclosure.

FIG. 4 is a front view of an embodiment of the disclosure.

### DETAILED DESCRIPTION OF THE INVENTION

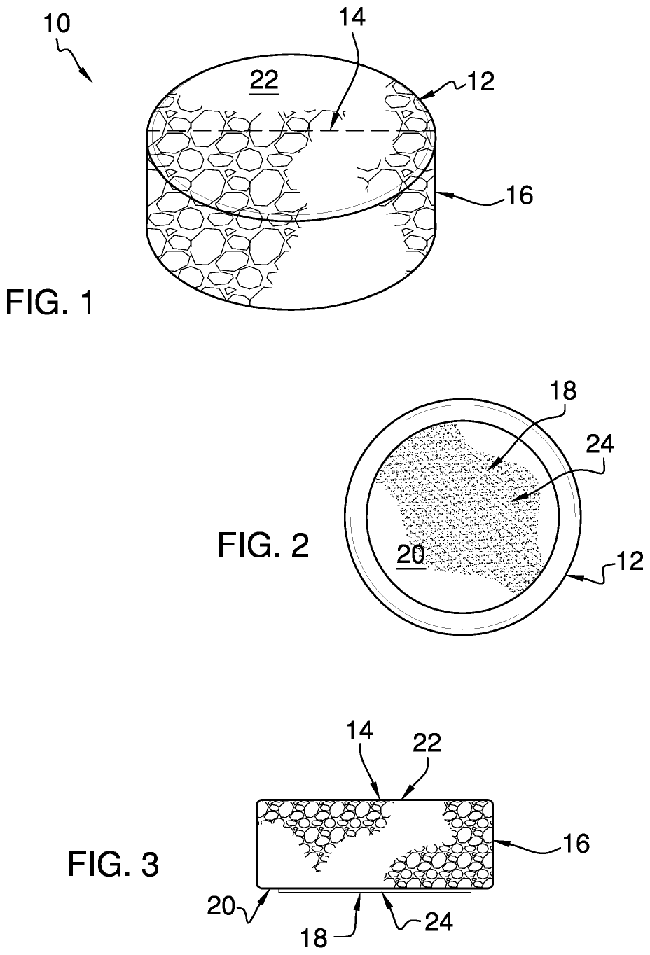

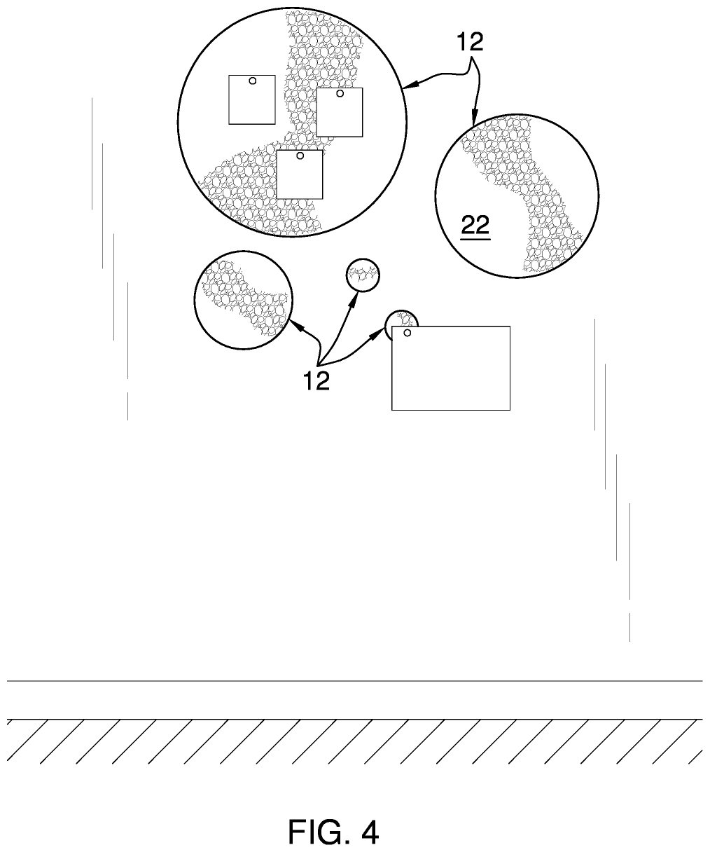

With reference now to the drawings, and in particular to FIGS. 1 through 4 thereof, a new mounting device embodying the principles and concepts of an embodiment of the disclosure and generally designated by the reference numeral 10 will be described.

As best illustrated in FIGS. 1 through 4, the removably attachable mounting device 10 generally comprises a block 12, which is resiliently deformable so that the block 12 is repeatedly penetrable by a shaft of a pin or thumbtack. The block 12 may be disc shaped, as shown in FIG. 1, or alternatively shaped, such as, but not limited to, rectangularly box shaped, ovally shaped, and the like. The block 12 comprises cork or elastomer. The block 12 has a diameter 14, which measures from 2.0 to 35.0 centimeters. The block 12 has a thickness 16, which measures from 0.75 to 1.25 centimeters. The thickness 16 may measure 0.95 centimeters to complement a length of the shaft of standard pins and thumbtacks.

A fastener 18 is engaged to a first face 20 of the block 12 and is configured to selectively engage a surface so that the block 12 is removably engaged to the surface. A second face 22 of the block 12 is configured to have an article, such as a poster, picture, or the like, positioned thereover. The shaft of the pin can be inserted through the article into the block 12 to mount the article to the surface. The fastener 18 may comprise an adhesive 24, or other fastening means, such as, but not limited to, suction cups, hook and loop fasteners, and the like. The adhesive 24 is pressure sensitive so that the adhesive 24 is removably engageable to the surface.

The block 12 is one of a set of blocks 12. The fasteners 18 are configured to removably engage the set of blocks 12 to the surface so that the article is positionable thereover. The blocks 12 are positioned for insertion of the shafts of the pins to mount the article to the surface. For example, four blocks 12 could be positioned singly on the surface so that they align with corners of a rectangularly shaped article.

In use, the block 12 is affixed to a wall by pressing the adhesive 24 positioned on the first face 20 of the block 12 against the wall. The article to be mounted to the surface is positioned over the second face 22 of the block 12, and the shaft of the pin is inserted through the article into the block 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A removably attachable mounting device comprising:
a block, the block being resiliently deformable, such that the block is repeatedly penetrable by a shaft of a pin; and
a fastener engaged to a first face of the block and being configured for selectively engaging a surface, such that the block is removably engaged to the surface, wherein a second face of the block is configured for positioning of an article thereover, such that the shaft of the pin can be inserted through the article into the block for mounting the article to the surface.

2. The removably attachable mounting device of claim 1, wherein the block is disc shaped.

3. The removably attachable mounting device of claim 1, wherein the block comprises cork or elastomer.

4. The removably attachable mounting device of claim 1, wherein the block has a diameter, the diameter measuring from 2.0 to 35.0 centimeters.

5. The removably attachable mounting device of claim 1, wherein the block has a thickness, the thickness measuring from 0.75 to 1.25 centimeters.

6. The removably attachable mounting device of claim 5, wherein the thickness measures 0.95 centimeters.

7. The removably attachable mounting device of claim 1, wherein the fastener comprises an adhesive.

8. The removably attachable mounting device of claim 7, wherein the adhesive is pressure sensitive such that the adhesive is removably engageable to the surface.

9. The removably attachable mounting device of claim 1, further including the block being one of a set of blocks, wherein the fasteners are configured for removably engaging the set of blocks to the surface such that the article is positionable thereover, wherein the blocks are positioned for insertion of the shafts of the pins for mounting the article to the surface.

10. A removably attachable mounting device comprising:
a block, the block being resiliently deformable, such that the block is repeatedly penetrable by a shaft of a pin, the block being disc shaped, the block comprising cork or elastomer, the block having a diameter, the diameter measuring from 2.0 to 35.0 centimeters, the block having a thickness, the thickness measuring from 0.75 to 1.25 centimeters;
a fastener engaged to a first face of the block and being configured for selectively engaging a surface, such that the block is removably engaged to the surface, wherein a second face of the block is configured for positioning of an article thereover, such that the shaft of the pin can be inserted through the article into the block for mounting the article to the surface, the fastener comprising an adhesive, the adhesive being pressure sensitive such that the adhesive is removably engageable to the surface; and
the block being one of a set of blocks, wherein the fasteners are configured for removably engaging the set of blocks to the surface such that the article is positionable thereover, wherein the blocks are positioned for insertion of the shafts of the pins for mounting the article to the surface.
